(19) United States
(12) Patent Application Publication
(10) Pub. No.: US 2025/0157445 A1
(43) Pub. Date: May 15, 2025

(54) PICKUP AND STRING INSTRUMENT

(71) Applicant: Yamaha Corporation, Hamamatsu (JP)

(72) Inventors: Kensuke OKADA, Hamamatsu (JP); Kenta ISHIZAKA, Hamamatsu (JP)

(21) Appl. No.: 19/021,826

(22) Filed: Jan. 15, 2025

Related U.S. Application Data
(63) Continuation of application No. PCT/JP2023/021292, filed on Jun. 8, 2023.

(30) Foreign Application Priority Data
Jul. 20, 2022 (JP) 2022-115614

(51) Int. Cl. G10H 3/18; H01F 27/28

(52) U.S. Cl. CPC G10H 3/181; H01F 27/28; G10H 2220/461

(57) ABSTRACT

A pickup includes a bobbin and a coil. The bobbin includes two plates, a plurality of magnets, and reinforcement parts. The two plates are spaced apart from each other in a plate thickness direction, and each of the two plates extends in a first direction perpendicular to the plate thickness direction. The magnets are attached to the two plates. Each of the magnets extends in the plate thickness direction between the two plates. The reinforcement parts connect the two plates together. The coil are wound around the plurality of magnets between the two plates. Each of the magnets includes two edge portions each of which faces the coil along the second direction. The magnets include end magnets located at both ends in the first direction. The reinforcement parts are positioned further outward along the first direction than the two edge portions of each of the end magnets.

### CROSS-REFERENCE TO RELATED APPLICATIONS

This application is a continuation application of International Application No. PCT/JP2023/021292, filed on Jun. 8, 2023, which claims priority to Japanese Patent Application No. 2022-115614 filed in Japan on Jul. 20, 2022. The entire disclosures of International Application No. PCT/JP2023/021292 and Japanese Patent Application No. 2022-115614 are hereby incorporated herein by reference.

### BACKGROUND

### Technical Field

The present invention relates to a pickup and a string instrument.

### Background Information

Japanese Examined Utility Model Application Publication No. S57-44392 discloses a pickup that is used in string instruments, such as electric guitars. The pickup comprises a bobbin, a plurality of magnets, and a coil. The bobbin has a pair of bobbin pieces (plates) formed in a plate shape and arranged in the plate thickness direction. The plurality of magnets each extend in the plate thickness direction of the bobbin pieces between the pair of bobbin pieces, and are attached to the bobbin so as to be arranged spaced apart from each other in the longitudinal direction of the bobbin, which is perpendicular to the plate thickness direction. The coil is wound around the plurality of magnets between the pair of bobbin pieces.

FIG. 4 of Japanese Examined Utility Model Application Publication No. S57-44392 discloses a pickup in which two ends of the plurality of magnets in the width direction of the bobbin pieces, which is perpendicular to the longitudinal direction and to the plate thickness direction of the bobbin pieces, face the coil with nothing interposed therebetween.

### SUMMARY

In such a pickup, the coil is tightly wound between the pair of plates (bobbin pieces) and thus is pressed against the plates in the plate thickness direction (the direction in which the pair of plates are aligned). Here, in a pickup in which the two ends of magnets in the width direction of the plates face the coil, the ends of the plates in the longitudinal direction of the bobbin have a cantilevered structure. Therefore, there is the problem that the two ends of the plates in the longitudinal direction are prone to warping outward due to the pressing force of the coil. It is not preferable for the two ends of the plates to warp outward because it becomes impossible to correctly position the pickup on the string instrument.

In consideration of the foregoing circumstance, an object of this disclosure is to provide a pickup and a string instrument that can prevent occurrence of warping at the ends of plates even if both sides of magnets in the width direction of the plates face the coil.

One aspect of this disclosure is a pickup comprising a bobbin and a coil. The bobbin includes two plates, a plurality of magnets, and reinforcement parts. The two plates are spaced apart from each other in a plate thickness direction, and each of the two plates extends in a first direction perpendicular to the plate thickness direction. The plurality of magnets are attached to the two plates and arranged in the first direction. Each of the plurality of magnets extends in the plate thickness direction between the two plates. The reinforcement parts connect the two plates together. The coil are wound around the plurality of magnets between the two plates. Each of the plurality of magnets includes two edge portions in a second direction, and each of the two edge portions faces the coil along the second direction. The second direction is perpendicular to the plate thickness direction and to the first direction. The plurality of magnets include end magnets that are located at both ends in the first direction. The reinforcement parts are positioned further outward along the first direction than positions of the two edge portions of each of the end magnets.

A second aspect of this disclosure is a string instrument comprising a string and the pickup. The pickup is configured to output an electrical signal corresponding to vibrations of the string.

### BRIEF DESCRIPTION OF THE DRAWINGS

FIG. 1 is a front view showing a string instrument according to a first embodiment of this disclosure.

FIG. 2 is a cross-sectional view showing a pickup according to the first embodiment of this disclosure.

FIG. 3 is a cross-sectional view through line III-III in FIG. 2.

FIG. 4 is a perspective view showing a state in which a coil and magnets have been removed from the pickup of FIGS. 2 and 3.

FIG. 5 is an enlarged view of part V in FIG. 3.

FIG. 6 is a cross-sectional view showing a state in which a pickup cover is attached to the pickup of FIG. 2.

FIG. 7 is a cross-sectional view showing a state in which a metal plate is attached to the pickup of FIG. 2.

FIG. 8 is a cross-sectional view showing a first modified example of a reinforcement part according to the first embodiment of this disclosure.

FIG. 9 is a cross-sectional view showing a second modified example of reinforcement parts according to the first embodiment of this disclosure.

FIG. 10 is a cross-sectional view showing a third modified example of reinforcement parts according to the first embodiment of this disclosure.

FIG. 11 is a cross-sectional view showing a main part of a pickup according to a second embodiment of this disclosure.

FIG. 12 is a cross-sectional view showing a first modified example of reinforcement parts according to the second embodiment of this disclosure.

FIG. 13 is a cross-sectional view showing a second modified example of a reinforcement part according to the second embodiment of this disclosure.

FIG. 14 is a cross-sectional view showing a modified example of the pickup according to the second embodiment of this disclosure.

FIG. 15 is a cross-sectional view showing a main part of a pickup according to another embodiment of this disclosure.

FIG. 16 is a cross-sectional view showing a main part of a pickup according to another embodiment of this disclosure.

### DETAILED DESCRIPTION OF THE EMBODIMENTS

### First Embodiment

Selected embodiments will now be explained with reference to the drawings. It will be apparent to those skilled in the field from this disclosure that the following descriptions of the embodiments are provided for illustration only and not for the purpose of limiting the invention as defined by the appended claims and their equivalents.

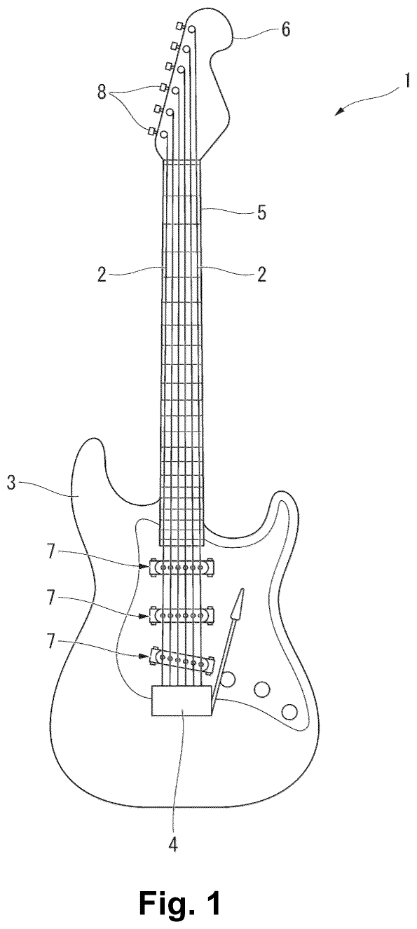

The first embodiment of this disclosure will be described below, with reference to FIGS. 1-5.

As shown in FIG. 1, a string instrument 1 of the first embodiment is a guitar having a plurality (six in the illustrated example) of strings 2. The string instrument 1 comprises a body 3, a bridge 4, a neck 5, a head 6, and a pickup 7.

The bridge 4 is provided on the body 3 and supports first ends of the strings 2. The neck 5 extends in one direction from the body 3. The head 6 is provided at the distal end of the direction in which the neck 5 extends and supports second ends of the strings 2. Specifically, the second ends of the strings 2 are wound by a winding device 8 provided on the head 6.

The pickup 7 is provided on the body 3. The pickup 7 is disposed so as to correspond to the plurality of strings 2 stretched between the bridge 4 and the head 6. In the string instrument 1 shown in FIG. 1, three pickups 7 are arranged in the longitudinal direction of the strings 2 (neck 5).

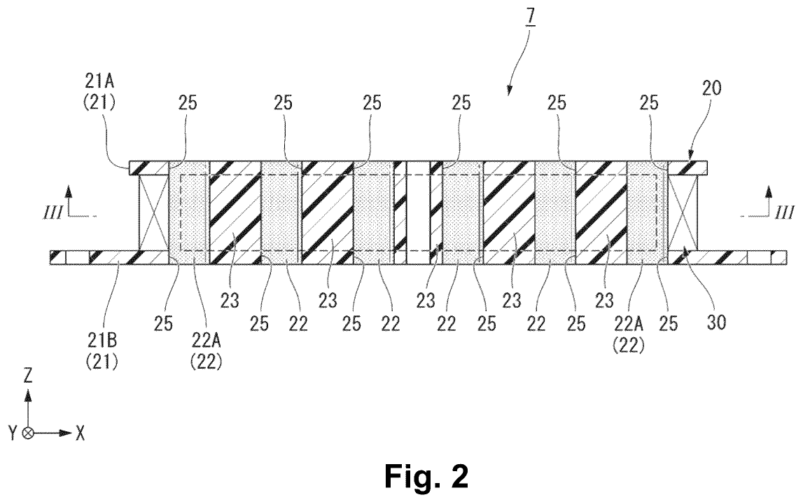

As shown in FIGS. 2-4, each of the pickups 7 includes a bobbin 20 and a coil 30. The bobbin 20 has two plates 21, a plurality of magnets 22, a plurality of connecting posts 23, and reinforcement parts 24.

The two plates 21 are arranged spaced apart from each other in the plate thickness direction thereof. Each of the plates 21 extends in a first direction perpendicular to the plate thickness direction. The dimension of each of the plates 21 in the first direction is greater than the dimension of each of the plates 21 in a second direction perpendicular to the plate thickness direction and to the first direction. That is, each of the plates 21 is formed in the shape of a long and narrow plate, with the first direction as the longitudinal direction and the second direction as the width direction thereof.

In FIGS. 2-5, the plate thickness direction of the plates 21 is indicated as the Z-axis direction and the longitudinal direction (first direction) of the plates 21 is indicated as the X-axis direction. In addition, the width direction (second direction) of the plates 21 is indicated as the Y-axis direction. In the following description, the positive direction along the Z axis (+Z side) may be referred to as the upper side and the negative direction along the Z-axis (−Z side) may be referred to as the lower side.

The dimensions (hereinafter referred to as the length dimensions) of the two plates 21 in the longitudinal direction can be equal to each other, for example. In the present embodiment, the length dimensions of the two plates 21 are different from each other. Specifically, of the two plates 21, the length dimension of a plate 21A (first plate 21A) on the upper side is smaller than the length dimension of a plate 21B (second plate 21B) on the lower side. In the present embodiment, the dimensions (hereinafter referred to as the width dimensions) of the two plates 21 in the width direction are equal to, but can be different from, each other, for example.

The plurality of magnets 22 each extend in the plate thickness direction of the plates 21 between the two plates 21. The plurality of magnets 22 are each attached to the two plates 21. The two ends of the magnets 22 in the plate thickness direction are inserted into insertion holes 25 formed on each of the plates 21, whereby each of the magnets 22 is attached to the two plates 21. The plurality of magnets 22 attached to the two plates 21 are arranged in the longitudinal direction of the plates 21. The number and positions of the magnets 22 correspond to the number and positions of the strings 2 shown in FIG. 1.

In the present embodiment, the magnets 22 are formed in a cylindrical shape with the axis in the plate thickness direction of the plates 21, but the magnets 22 can be formed in a rectangular column shape, for example.

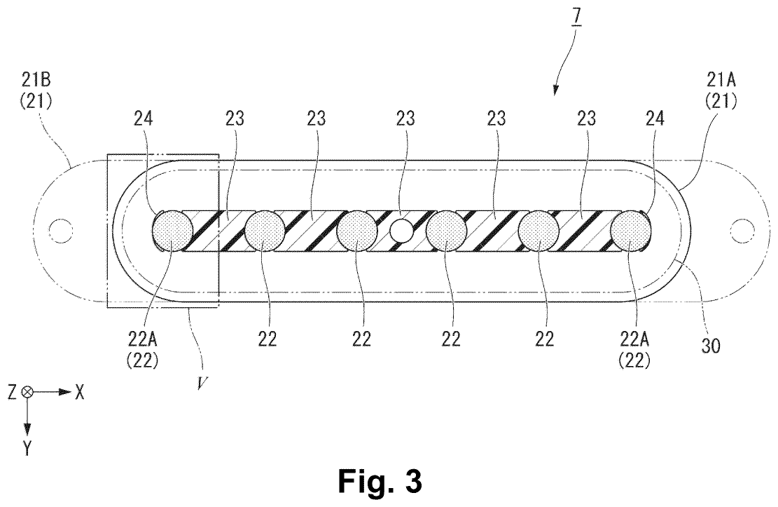

The plurality of connecting posts 23 each extend in the plate thickness direction of the plates 21 between the two plates 21 and connect the two plates 21 to each other. Each of the connecting posts 23 is arranged between magnets 22 that are adjacent to each other in the longitudinal direction of the plates 21. As shown in FIG. 3, the width dimension of each of the connecting posts 23 is equal to the width dimension of the magnets 22. The two ends of the magnets 22 can thereby be positioned so as to respectively correspond to the two ends of the connecting posts 23 in the width direction of the plates 21. Furthermore, the two ends of the connecting posts 23 in the longitudinal direction of the plates 21 are formed in a concave shape that matches the circumferential surfaces of the magnets 22. As a result, it is possible to reduce the clearance between the magnets 22 and the connecting posts 23 in the longitudinal direction of the plates 21. By providing the plurality of connecting posts 23 in this manner, the two ends of the magnets 22 in the width direction are exposed to the outside unless the ends are covered by the coil 30, described further below.

In the present embodiment, the plurality of connecting posts 23 are formed integrally with the two plates 21, but can be formed separately from the two plates 21 and then fixed to the two plates 21, for example.

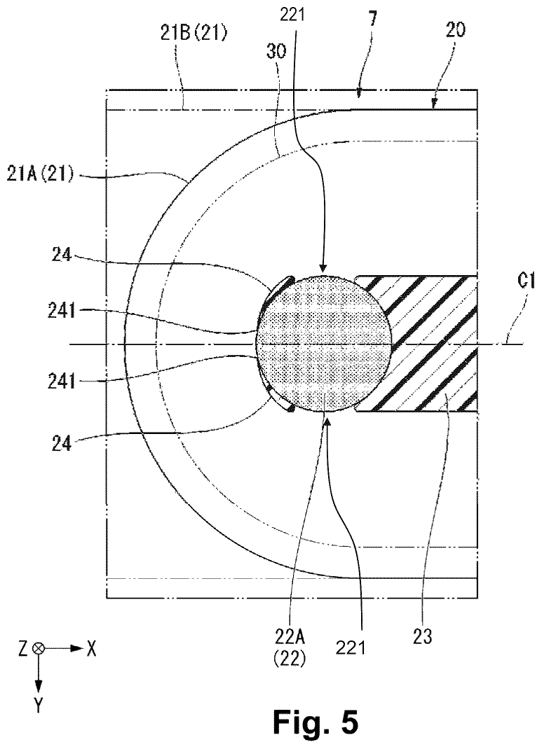

As shown in FIGS. 3-5, the reinforcement parts 24 extend in the plate thickness direction of the plates 21 between the two plates 21 and connect the two plates 21 together, in the same manner as the connecting posts 23. The reinforcement parts 24 are connected to the two plates 21 at locations corresponding to, of the plurality of magnets 22, magnets 22A (hereinafter referred to as end magnets 22A) located at the end portions of the plates 21 in the longitudinal direction. In addition, the reinforcement parts 24 are located further outward in the longitudinal direction of the plates 21 than the positions of portions (edge portions in the width direction) of the end magnets 22A, and the portions face the coil 30, described further below, in the width direction. For example, as illustrated in FIG. 5, the two reinforcement parts 24 are located further outward in the negative direction along the X axis than the positions of the edge portions 221 facing the coil 30 in the width direction. Furthermore, the reinforcement parts 24 are in contact with the end magnets 22A. In addition, the reinforcement parts 24 are formed separately from the connecting posts 23 and are located spaced apart from the connecting posts 23 in the longitudinal direction of the plates 21. The reinforcement parts 24 are provided at each of the locations corresponding to the two end magnets 22A located at the two end portions of the plates 21 in the longitudinal direction.

The reinforcement parts 24 of the present embodiment will be described in further detail below.

As shown in FIG. 5, as viewed from the plate thickness direction of the plates 21, the two reinforcement parts 24 are arranged spaced part from each other in the width direction of the plates 21. The two reinforcement parts 24 are disposed on both sides of a center line C1 of the end magnet 22A in the width direction of the plates 21. Each of the reinforcement parts 24 is formed in an arc shape conforming to the circumferential surface of the end magnet 22A. In addition, each of the reinforcement parts 24 is formed such that the thickness of the reinforcement part 24 corresponding to the radial direction of the end magnet 22A increases with increasing distance in the width direction from the center line C1 of the end magnet 22A. Additionally, each of the reinforcement parts 24 is formed so as not to protrude outside of the two edges of the end magnet 22A in the width direction of the plates 21.

As shown in FIGS. 2 and 3, the coil 30 is wound around the plurality of magnets 22 between the two plates 21. In the present embodiment, the coil 30 that is wound around the plurality of magnets 22 is located on the outer side of the plurality of connecting posts 23 and the reinforcement parts 24. That is, the coil 30 is also wound around the plurality of connecting posts 23 and the reinforcement parts 24.

In a state in which the coil 30 is wound as described above, the two edge of each of the magnets 22 in the width direction face the coil 30 with nothing interposed therebetween in the width direction. Therefore, the distance between the magnets 22 and the coil 30 is small.

The pickup 7 is mounted on the body 3 (refer to FIG. 1) of the string instrument 1 such that the longitudinal direction of the plates 21 is oriented in the direction in which the plurality of strings 2 (refer to FIG. 1) are arranged, and that the width direction of the plates 21 is oriented in the longitudinal direction of the strings 2. The pickup 7 outputs an electrical signal corresponding to the vibration of each of the strings 2. Specifically, the pickup 7 detects the vibration of each of the strings 2 as electromagnetic induction, converts the same into an electrical signal, and outputs the electrical signal.

As described above, in the pickup 7 of the present embodiment, the end portions of the two plates 21 in the longitudinal direction of the plates 21 each have a cantilevered structure. The end portions of these two plates 21 are connected via the reinforcement parts 24. Therefore, the reinforcement parts 24 restrict the end portions of the two plates 21 from moving away from each other in the plate thickness direction. Accordingly, even if the coil 30 that is wound around the plurality of magnets 22 presses against the end portions of the plates 21, the reinforcement parts 24 can suppress occurrence of warping at the end portions of the plates 21.

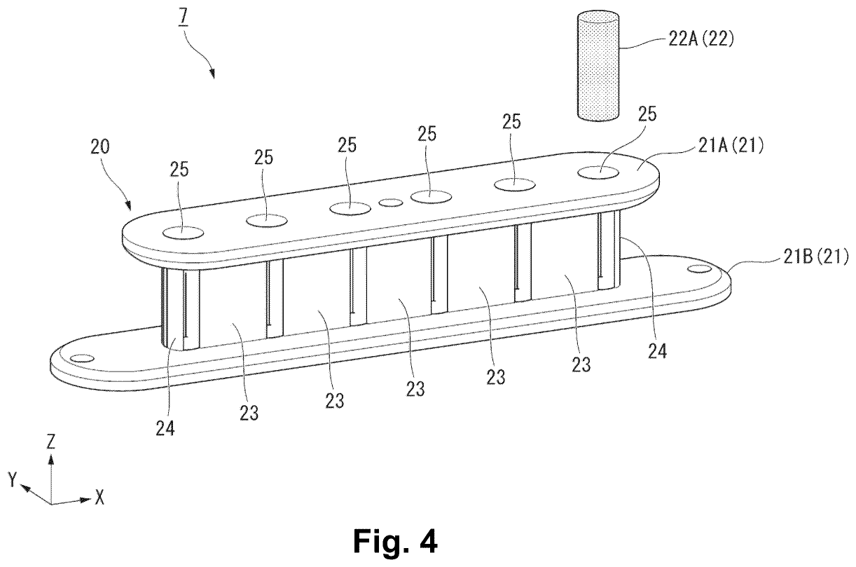

In addition, in the pickup 7 of the present embodiment, the bobbin 20 is provided with the reinforcement parts 24, and the two edges of each of the magnets 22 in the width direction face the coil 30 with nothing interposed therebetween. Therefore, compared to a pickup (for example, the device disclosed in Japanese Examined Utility Model Application Publication No., FIG. 4) in which the bobbin 20 does not have the reinforcement parts 24 and the two edges of the magnets 22 in the width direction face the coil with nothing interposed therebetween, changes in the positional relationship between the plurality of magnets 22 and the coil 30 can be kept small. Accordingly, changes in the characteristics of the pickup 7 can be kept small compared to a pickup that does not have the reinforcement parts 24.

In addition, in the pickup 7 of the present embodiment, the coil 30 that is wound around the plurality of magnets 22 is located on the outer side of the reinforcement parts 24. Therefore, the coil 30 can be easily wound around the plurality of magnets 22 compared to a case in which the coil 30 is passed between the reinforcement parts 24 and the end magnets 22A. Accordingly, the pickup 7 can be manufactured easily.

In addition, in the pickup 7 of the present embodiment, the reinforcement parts 24 are in contact with the end magnets 22A. Therefore, the coil 30 that is wound around the plurality of magnets 22 can be disposed closer to the end magnets 22A compared to a case in which the reinforcement parts 24 are located away from the end magnets 22A. That is, compared to a case in which there are no reinforcement parts 24, changes in the state of the coil 30 that is wound around the plurality of magnets 22 can be kept small. As a result, changes in the electromagnetic characteristics of the pickup 7 can be kept small compared to a case in which there are no reinforcement parts 24. Accordingly, changes in the electrical signal that is output from the pickup 7 in accordance with vibrations of the strings 2 can be kept small.

Additionally, in the present embodiment, the reinforcement parts 24 are formed in an arc shape conforming to the circumferential surfaces of the end magnets 22A. In addition, the reinforcement parts 24 are formed so as not to protrude outside of the two edges of the end magnets 22A in the width direction of the plates 21. As a result, compared to a case in which there are no reinforcement parts 24, changes in the state of the coil 30 that is wound around the plurality of magnets 22 can be further reduced.

The string instrument 1 according to the present embodiment adopts the pickup 7 in which warping of the end portions of the plates 21 is suppressed, as described above. Therefore, the pickup 7 can be positioned on the string instrument 1 with high precision. Accordingly, a user playing the string instrument 1 can adjust the string height (position of the strings 2 with respect to the pickup 7) with higher precision.

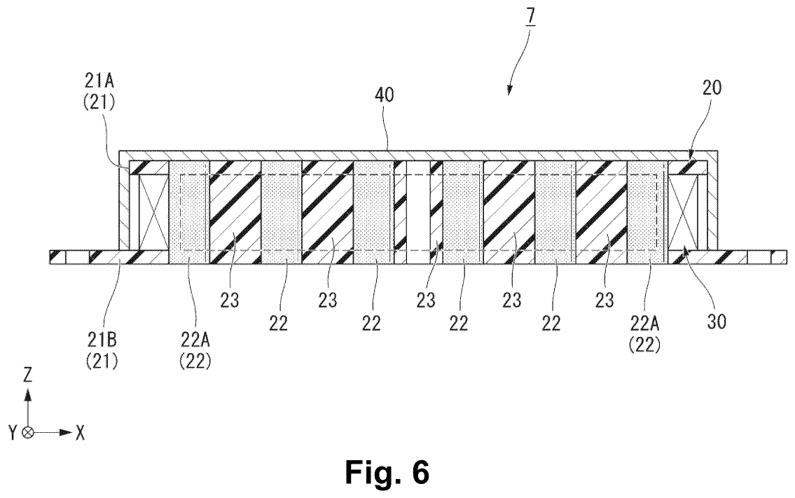

In addition, in the string instrument 1 according to the present embodiment, the string height can be adjusted with high precision even when the upper side (strings 2 side) of the pickup 7 is covered by a pickup cover 40, for example, as shown in FIG. 6. This point will be described below. When the upper side of the pickup 7 (first plate 21A) is covered by the pickup cover 40, the string height is set with reference to the position of the pickup cover 40. However, if the end portions of the first plate 21A warp upward, the position of the pickup cover 40 relative to the pickup 7 will vary, making it difficult to correctly set the string height. In contrast, by suppressing warping of the end portions of the plates 21 as in the present embodiment, it is possible to prevent occurrence of variation in the position of the pickup cover 40 relative to the pickup 7. Therefore, the string height can be adjusted with high precision. The pickup cover 40 illustrated in FIG. 6 is provided on the pickup 7 located on the neck 5 side in the string instrument 1 shown in FIG. 1, for example.

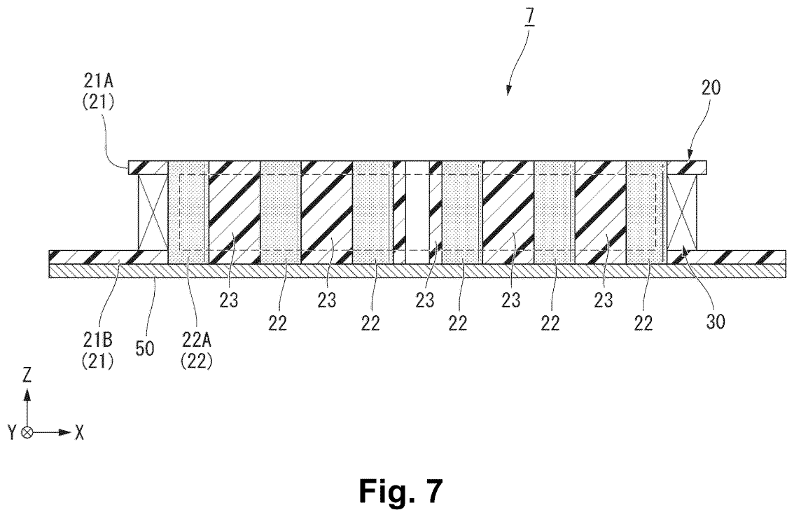

In addition, as a result of the warping of the ends portions of the plates 21 being suppressed, for example as shown in FIG. 7, even if a metal plate 50 that can be magnetized is disposed below the pickup 7 (second plate 21B), the clearance between the metal plate 50 and the pickup 7 (second plate 21B) can be reduced. Therefore, it is possible to prevent the metal plate 50 from being positioned away from the magnets 22 and the coil 30, thereby increasing the magnetic force in the pickup 7. Accordingly, it becomes possible to provide the string instrument 1 that has the pickup 7 with high gain. The metal plate 50 shown in FIG. 7 is provided for the pickup 7 located on the bridge 4 side in the string instrument 1 shown in FIG. 1, for example.

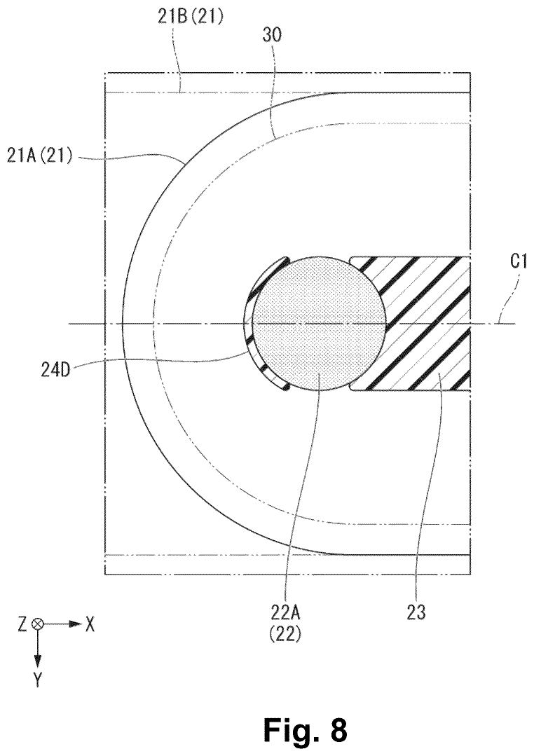

In the first embodiment, for example as shown in FIG. 8, when viewed from the plate thickness direction of the plates 21, one reinforcement part 24D in contact with the end magnet 22A can be formed in an arc shape extending along the circumferential surface of the end magnet 22A, starting from the center line C1 of the end magnet 22A in the width direction of the plates 21. In other words, the two reinforcement parts 24 in FIG. 5 can be integrally formed.

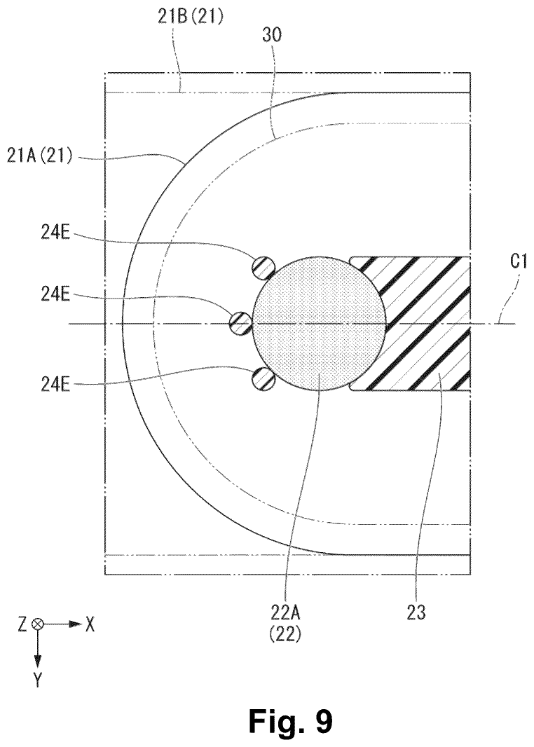

In the first embodiment, for example as shown in FIG. 9, when viewed from the plate thickness direction of the plates 21, a plurality of reinforcement parts 24E, each formed in a dot shape and in contact with the end magnet 22A, can be arranged along the circumferential surface of the end magnet 22A. In this case, it suffices if at least one of the dot-shaped reinforcement parts 24E is located on or near the center line C1 of the end magnet 22A in the width direction of the plates 21.

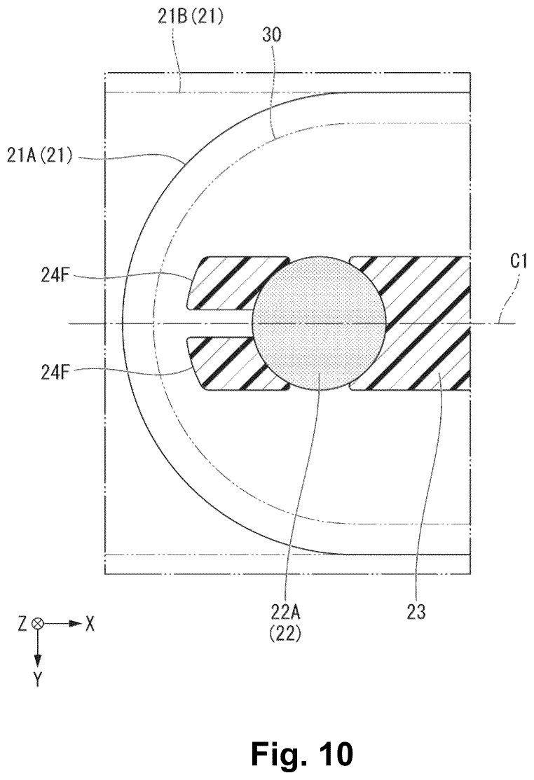

In the first embodiment, for example as shown in FIG. 10, when viewed from the plate thickness direction of the plates 21, reinforcement parts 24F in contact with the end magnet 22A can extend outward of the end magnet 22A in the longitudinal direction of the plates 21. In this configuration, portions of the two plates 21 that are spaced outward from the end magnets 22A in the longitudinal direction are connected by the reinforcement parts 24F. Therefore, warping of the end portions of the plates 21 can be more effectively suppressed. In FIG. 10, two of the reinforcement parts 24F are arranged on both sides of the center line C1 of the end magnet 22A in the width direction of the plates 21, but the invention is not limited thereto.

### Second Embodiment

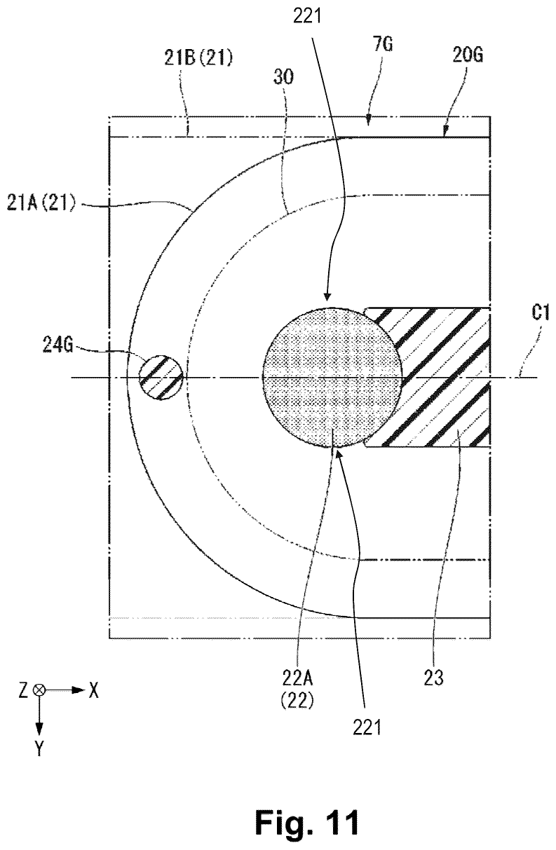

The second embodiment of this disclosure will be described next with reference to FIG. 11. In the following description, the configurations that are the same as those already explained have been assigned the same reference numerals and redundant descriptions have been omitted.

In the second embodiment, in a pickup 7G of the second embodiment, reinforcement parts 24G that connect the two plates 21 together are connected to portions of the plates 21, which are located further outward in the longitudinal direction of the plates 21 than the positions of the portions (edge portions in the width direction) of the end magnets 22A, and the portions of the end magnets 22A face the coil 30 in the width direction, in the same manner as in the first embodiment. For example, as shown in FIG. 11, one reinforcement part 24G is connected to portions of the plates 21, which are located further outward in the negative direction along the X-axis than the end portions 221 of the magnetic part 22A, which face the coil 30 in the width direction. Although not illustrated, the other reinforcement part 24G is connected to portions of the plates 21, which are located further outward in the positive direction along the X-axis than the end portions of the other end magnet 22A, which face the coil 30 in the width direction. However, in the second embodiment, the reinforcement parts 24G are located outwardly and spaced away from the end magnets 22A in the longitudinal direction of the plates 21.

Specifically, the reinforcement parts 24G are located on the center line C1 of the end magnets 22A in the width direction of the plates 21. The reinforcement parts 24G can be located shifted in the width direction with respect to the center line C1 of the end magnets 22A, for example. In addition, as shown in FIG. 11, the reinforcement parts 24G are formed in a dot shape as viewed from the plate thickness direction of the plates 21.

In the pickup 7G of the second embodiment, the coil 30 (refer to FIGS. 2 and 3) wound around the plurality of magnets 22 is located between the reinforcement parts 24G and the end magnets 22A.

In order to position the coil 30 between the reinforcement parts 24G and the end magnets 22A, the reinforcement parts 24G can be attached to the two plates 21 after winding the coil 30 around the plurality of magnets 22, for example.

The pickup 7G and the string instrument 1 of the second embodiment can exhibit the same effects as those of the first embodiment.

In addition, in the pickup 7G of the second embodiment, the reinforcement parts 24G are located away from the end magnets 22A. Therefore, compared to a case in which the reinforcement parts 24G are in contact with the end magnets 22A, the reinforcement parts 24G can be arranged near the edges of the end portions of the plates 21. Here, the “edges of the end portions of the plates 21” are places where the displacement in the plate thickness direction due to warping of the plates 21 tends to become large. By arranging the reinforcement parts 24G near the edges of the end portions of the plates 21, warping of the ends of the plates 21 can be more effectively suppressed.

In addition, as a result of the reinforcement parts 24G being located away from the end magnets 22A, compared to a case in which the reinforcement parts 24G are in contact with the end magnets 22A and extend toward the edges of the end portions of the plates 21, as shown in FIG. 10, it is possible to reduce the amount of material required for producing the bobbin 20 (particularly the portions including the reinforcement parts 24G). It is thereby possible to reduce manufacturing costs of the pickup 7G.

In addition, in the pickup 7G of the second embodiment, the coil 30 is located between the reinforcement parts 24G and the end magnets 22A. Therefore, changes in the positional relationship between the plurality of magnets 22 and the coil 30 can be kept small compared to a pickup that does not have the reinforcement parts 24G. Accordingly, changes in the characteristics of the pickup can be kept small compared to a pickup that does not have the reinforcement parts 24G.

In addition, as a result of the coil 30 being located between the reinforcement parts 24G and the end magnets 22A, the coil 30 that is wound around the plurality of magnets 22 can be formed more compactly, compared to a case in which the coil 30 is located on the outer side of the reinforcement parts 24G. Accordingly, it is possible to prevent the pickup 7G from becoming large.

Furthermore, as a result of the coil 30 being located between the reinforcement parts 24G and the end magnets 22A, the reinforcement parts 24G connect the two plates 21 on the outer side of the coil 30 wound around the plurality of magnets 22. Therefore, even if stress caused by the winding of the coil 30 acts on the end portions of the two plates 21, the reinforcement parts 24G can more effectively restrict the ends portions of the two plates 21 from moving away from each other in the plate thickness direction thereof.

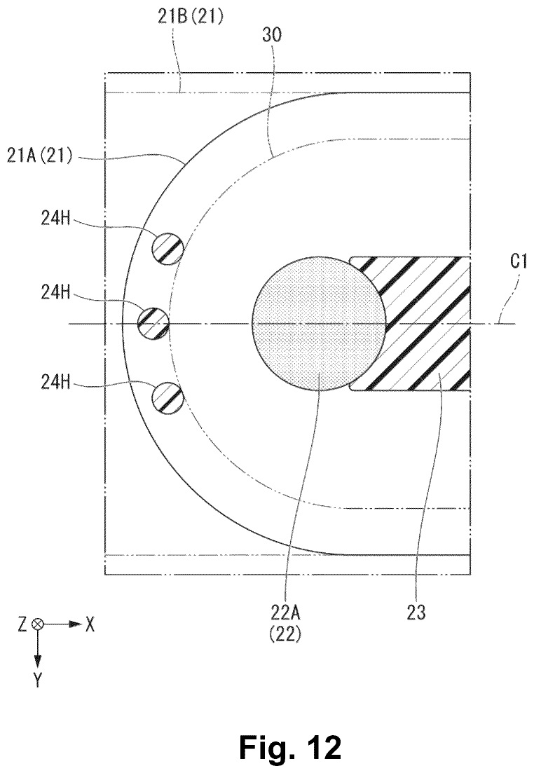

In the second embodiment, for example as shown in FIG. 12, when viewed from the plate thickness direction of the plates 21, a plurality of reinforcement parts 24H formed in a dot shape can be arranged conforming to the circumferential surfaces of the end magnets 22A at positions away from the end magnets 22A. In FIG. 12, all three of the reinforcement parts 24H are located on the outer side of the end magnet 22A in the longitudinal direction of the plates 21, but it suffices if at least one of the reinforcement parts 24H is located on the outer side of the end magnet 22A.

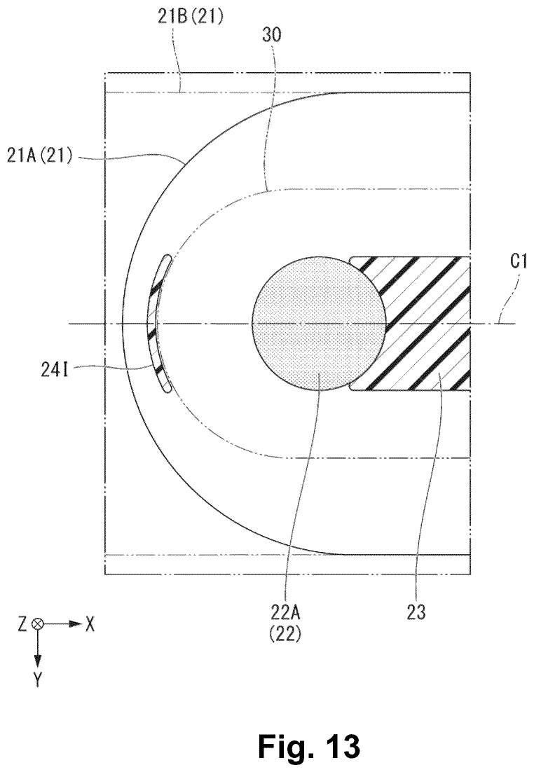

In the second embodiment, for example as shown in FIG. 13, when viewed from the plate thickness direction of the plates 21, one reinforcement part 24I can extend in an arc shape conforming to the circumferential surface of the end magnet 22A at a position away from the end magnet 22A. In FIG. 13, the entirety of the reinforcement part 24I is located on the outer side of the end magnet 22A in the longitudinal direction of the plates 21, but it suffices if at least a portion of the reinforcement part 24I is located on the outer side of the end magnet 22A.

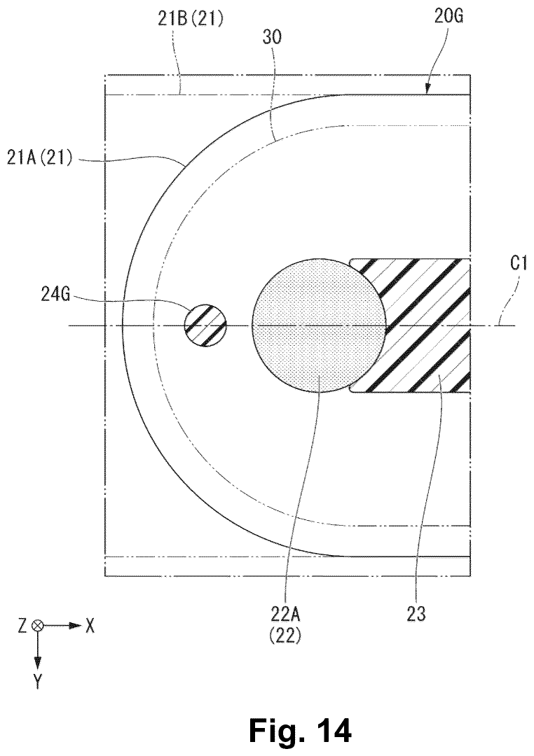

In the pickup 7G of the second embodiment, for example as shown in FIG. 14, the coil 30 can, in a state of being wound around the plurality of magnets 22, be located on the outer side of the reinforcement parts 24G which are disposed away from the end magnets 22A. In this case, the coil 30 can be more easily wound around the plurality of magnets 22 compared to a case in which the coil 30 is passed between the reinforcement parts 24G and the end magnets 22A. Accordingly, the pickup 7G can be manufactured easily.

This disclosure was described in detail above, but this disclosure is not limited to the embodiments described above, and can be modified within the scope of the spirit of this disclosure.

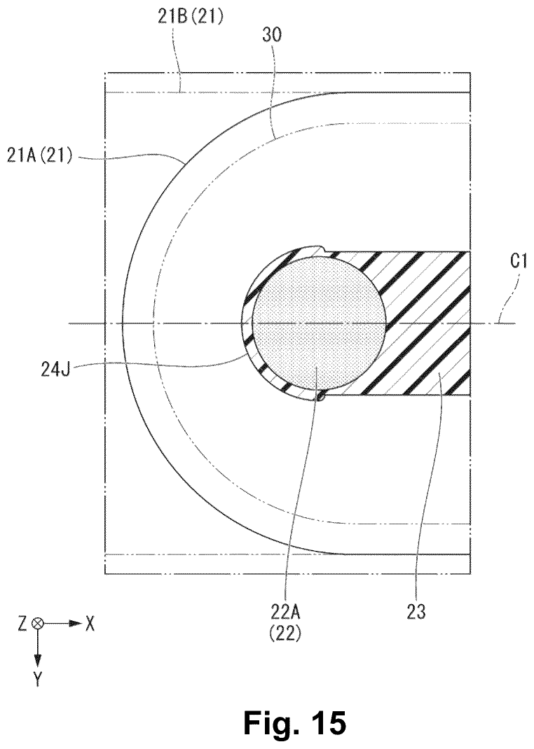

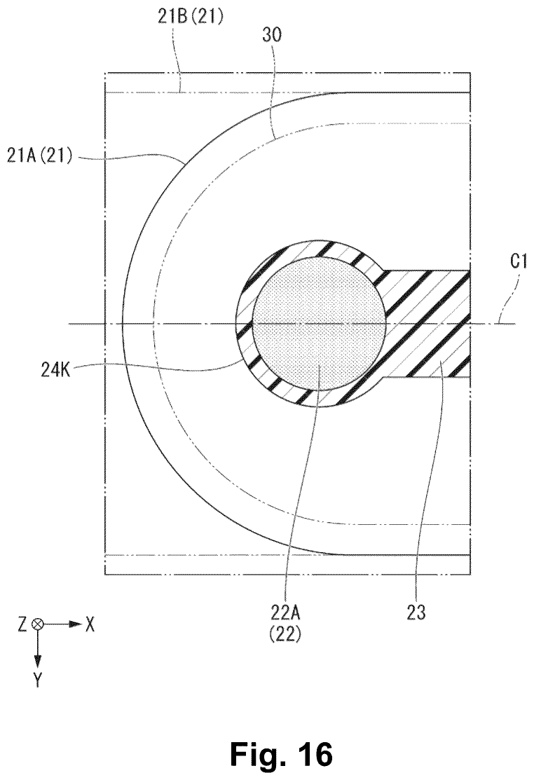

In this disclosure, for example as shown in FIGS. 15 and 16, reinforcement parts 24J, 24K can be formed integrally with the connecting posts 23.

In FIG. 15, when viewed from the plate thickness direction of the plates 21, the reinforcement part 24J is formed in an arc shape extending along the circumferential surface of the end magnet 22A. In addition, the reinforcement part 24J is connected to the connecting post 23 on both sides of the end magnet 22A in the width direction of the plates 21. As a result, the end magnet 22A is surrounded by the connecting post 23 and the reinforcement part 24J. In FIG. 15, the width dimension of the reinforcement part 24J is greater than the width dimension of the connecting post 23.

In FIG. 16, when viewed from the plate thickness direction of the plates 21, the reinforcement part 24K is formed in a ring shape surrounding the end magnet 22A. In addition, the reinforcement part 24K is connected to the connecting post 23 at the inner side (the positive direction side along the X-axis in FIG. 16) of the end magnet 22A in the longitudinal direction of the plates 21. In FIG. 16, the width dimension of the connecting post 23 is smaller than the width dimension of the magnet 22 (end magnet 22A) and the width dimension of the reinforcement part 24K, but can be larger than the width dimensions of the magnet 22 (end magnet 22A) and the reinforcement part 24K, for example.

In FIGS. 15 and 16, the reinforcement parts 24J, 24K are in contact with the end magnet 22, but can be located away from the end magnet 22, for example.

In the present embodiment, the number of connecting posts provided on the bobbin can be one, for example. In this case, a plurality of insertion holes, into which the plurality of magnets are respectively inserted in the plate thickness direction, can be formed on the connecting post. The two ends of the plurality of insertion holes of the connecting post simply need to be aligned with the plurality of insertion holes of the plates.

In the present embodiment, the bobbin can be configured by two plates, a plurality of magnets, and reinforcement parts, without including connecting posts, for example.

The pickup of this disclosure is not limited to being applied to a guitar, and can be applied to any string instrument that generates sound by vibration of strings.

According to this disclosure, the reinforcement parts can suppress occurrence of warping at the ends of plates that constitute a pickup.

What is claimed is:

1. A pickup comprising:
a bobbin including
two plates spaced apart from each other in a plate thickness direction, each of the two plates extending in a first direction perpendicular to the plate thickness direction,
a plurality of magnets attached to the two plates, and arranged in the first direction, each of the plurality of magnets extending in the plate thickness direction between the two plates, and
reinforcement parts connecting the two plates together; and
a coil wound around the plurality of magnets between the two plates,
each of the plurality of magnets including two edge portions in a second direction, each of the two edge portions facing the coil along the second direction, the second direction being perpendicular to the plate thickness direction and to the first direction, and
the plurality of magnets including end magnets that are located at both ends in the first direction, and
the reinforcement parts being positioned further outward along the first direction than positions of the two edge portions of each of the end magnets.

2. The pickup according to claim 1, wherein
the reinforcement parts are located away from the end magnets.

3. The pickup according to claim 2, wherein
the coil is located between the reinforcement parts and the end magnets, in a state of being wound around the plurality of magnets.

4. The pickup according to claim 2, wherein
the coil is located on an outer side of the reinforcement parts in a state of being wound around the plurality of magnets.

5. The pickup according to claim 1, wherein
the reinforcement parts are in contact with the end magnets.

6. A string instrument comprising:
a string; and
the pickup according to claim 1,
the pickup being configured to output an electrical signal corresponding to vibrations of the string.
